(19) United States
(12) Patent Application Publication
(10) Pub. No.: US 2019/0014325 A1
(43) Pub. Date: Jan. 10, 2019

(54) VIDEO ENCODING METHOD, VIDEO DECODING METHOD, VIDEO ENCODER AND VIDEO DECODER

(71) Applicant: INDUSTRIAL TECHNOLOGY RESEARCH INSTITUTE, Hsinchu (TW)

(72) Inventors: Ching-Chieh LIN, Taipei City (TW); Chun-Lung LIN, Taipei City (TW); Po-Han LIN, Taipei City (TW)

(73) Assignee: INDUSTRIAL TECHNOLOGY RESEARCH INSTITUTE, Hsinchu (TW)

(21) Appl. No.: 15/852,828

(22) Filed: Dec. 22, 2017

Related U.S. Application Data
(60) Provisional application No. 62/528,546, filed on Jul. 5, 2017.

(51) Int. Cl. H04N 19/159; H04N 19/119; H04N 19/176; H04N 19/196; H04N 19/56; H04N 19/154

(52) U.S. Cl. CPC H04N 19/159; H04N 19/119; H04N 19/154; H04N 19/196; H04N 19/56; H04N 19/176

(57) ABSTRACT

A video encoding method, a video decoding method, a video encoder and a video decoder are provided. The video encoding method includes the followings. An image is received. The image is divided into a plurality of blocks. An encoding procedure is performed on each of the plurality of blocks, wherein the encoding procedure includes the followings. A particular block in the blocks is uniformly divided into a plurality of sub-blocks with the same size according to a segmentation parameter. An intra prediction is performed on the respective sub-blocks, so that a plurality of prediction modes corresponding to the sub-blocks is found. The sub-blocks are indexed according to the prediction modes and an index map is generated accordingly. The index code information is generated according to the index map. The particular block is encoded according to the index coding information so that video coding data is generated correspondingly.

### TECHNICAL FIELD

The present disclosure relates to methods and devices for image processing, and more specifically, to a video encoding method, a video decoding method, a video encoder, and a video decoder.

### BACKGROUND

Recently, as the demand for the video quality has been increasing, how to provide a video codec technology capable of supporting the high-resolution video and the high frame rate has become one of the industry's major topics. Take Virtual Reality (VR) 360 as an example. In order to provide good immersive experiences for the users, the requirement for the video resolution may be up to 8K, 16K or even 32K. Moreover, the frame rate requirement may also be up to 90 frames per second (FPS), or even 120 FPS.

The traditional video encoding technology may divide an image into a plurality of blocks for encoding. Generally, a simple background of the image may be partitioned into large sub-blocks for encoding to achieve a better compression ratio, and an image area including complex details may be partitioned into small sub-blocks to get a better video quality.

### SUMMARY

The present disclosure relates to a video encoding method, a video decoding method, a video encoder, and a video decoder. According to the embodiments of the present disclosure, each block in the image is uniformly partitioned into a plurality of sub-blocks with the same size. In this way, the device does not need to record or process the quad-tree partition information of each block of the image when performing encoding and decoding processes on the image, so that the computation loading on the device can be reduced. In addition, the uniform-partitioned sub-blocks in each block may be indexed after the intra prediction is performed, so that each block in the image may be converted into an indexed map. The index map may be further compressed into encoded index information for the subsequent encoding and decoding processes to improve the codec performance.

According to an aspect of the present disclosure, a video encoding method is provided. The video encoding method may be implemented by an electronic device including a processor. The video encoding method includes the following steps: an image is received by the processor; the image is partitioned into a plurality of blocks by the processor; and an encoding process is executed for each of the blocks by the processor, wherein the encoding process includes steps of: partitioning a specific block of the blocks into a plurality of sub-blocks with the same size according to a partition parameter determining a depth of partition of the specific block; performing an intra prediction on each of the sub-blocks to search for a plurality of prediction modes for the sub-blocks; indexing the sub-blocks according to the prediction modes to generate an index map including a plurality of prediction mode indexes for indicating the prediction modes; generating encoded index information according to the index map; and encoding the specific block according to the encoded index information to generate corresponding encoded video data.

According to another aspect of the present disclosure, a video encoder is provided. The video encoder includes a memory and a processor. The processor is coupled to the memory and configured for: receiving an image; partitioning the image into a plurality of blocks; and executing an encoding process for each of the blocks, wherein the encoding process includes steps of: partitioning a specific block of the blocks into a plurality of sub-blocks with the same size according to a partition parameter determining a depth of partition of the specific block; performing an intra prediction on each of the sub-blocks to search for a plurality of prediction modes for the sub-blocks; indexing the sub-blocks according to the prediction modes to generate an index map including a plurality of prediction mode indexes for indicating the prediction modes; generating encoded index information according to the index map; and encoding the specific block according to the encoded index information to generate corresponding encoded video data.

According to yet another aspect of the present disclosure, a video decoding method is provided. The video decoding method may be implemented by an electronic device including a processor. The video decoding method includes the following steps: encoded video data corresponding to a block is received, wherein the block is uniformly partitioned into a plurality of sub-blocks with the same size; an index map corresponding to the block is reconstructed according to encoded index information, wherein the index map includes a plurality of prediction mode indexes respectively corresponding to a plurality of prediction modes obtained by performing an intra prediction on the sub-blocks; and each pixel value in the sub-blocks is reconstructed according to the prediction mode indexes of the index map and the prediction modes obtained by performing the intra prediction on the sub-blocks based on the prediction mode indexes.

According to yet another aspect of the present disclosure, a video decoder is provided. The video decoder includes a memory and a processor. The processor is coupled to the memory and configured for: receiving encoded video data corresponding to a block, wherein the block is uniformly partitioned into a plurality of sub-blocks with the same size; reconstructing an index map corresponding to the block according to encoded index information, wherein the index map comprises a plurality of prediction mode indexes respectively corresponding to a plurality of prediction modes obtained by performing an intra prediction on each of the sub-blocks; and reconstructing each pixel value in the sub-blocks according to the prediction mode indexes of the index map and the prediction modes obtained by performing the intra prediction on each of the sub-blocks based on the prediction mode indexes.

For a better understanding of the above and other aspects of the disclosure, the embodiments are described below in detail with reference to the accompanying drawings.

### BRIEF DESCRIPTION OF THE DRAWINGS

FIG. 1 is a block diagram of a video encoder according to an embodiment of the present disclosure.

FIG. 2 is a flow chart of a video encoding method according to an embodiment of the invention.

FIG. 3 is a schematic diagram showing that a block of the image is uniformly partitioned into a plurality of sub-blocks with the same size.

FIG. 4 is a flow chart of determining the partition parameter according to an embodiment of the present disclosure.

FIG. 5 is a schematic diagram of determining the partition parameter according to the flow chart of FIG. 4.

FIG. 6 is a flow chart of determining the partition parameter according to another embodiment of the present disclosure.

FIGS. 7A to 7C are schematic diagrams of determining the partition parameter according to the flow of FIG. 6.

FIG. 8 is a schematic diagram illustrating the intra prediction for a sub-block of the block.

FIG. 9A is a schematic diagram of an index map generated by indexing each sub-block in the block.

FIG. 9B is a schematic diagram illustrating a plurality of prediction angles and the corresponding prediction mode indexes.

FIG. 10 is a schematic diagram of an adjusted index map generated by adjusting the prediction mode indexes in the index map.

FIG. 11A to FIG. 11E illustrate examples of scanning patterns for the index map.

FIG. 12 is a block diagram of a video decoder according to an embodiment of the present disclosure.

FIG. 13 is a flow chart of a video decoding method according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The present disclosure provides a video encoding method, a video decoding method, a video encoder, and a video decoder. Video encoding may be used to compress video data to reduce the amount of data to be transferred.

Video decoding may be used to decompress the compressed video data to restore the video data.

The video encoding method and the video decoding method of the present disclosure may be implemented by an electronic device. For example, the electronic device includes a memory and a processor. The memory may store programs, instructions, data or files that are accessible and executable for the processor. The processor is coupled to the memory, and may be configured to perform the video encoding method and the video decoding method according to the embodiments of the present disclosure. The processor may be implemented as, for example, a microcontroller, a microprocessor, a digital signal processor, an application specific integrated circuit (ASIC), a digital logic circuit, a field programmable gate array (FPGA), or other hardware having processing functions.

The video encoding method and the video decoding method of the present disclosure may also be implemented as one or more software programs that can be stored in a non-transitory computer readable storage medium, such as a hard disk, a compact disc, a flash drive, and a memory. When the processor loads the software program from the non-transitory computer readable storage medium, the video encoding method and the video decoding method of the present disclosure can be executed. In addition, it should be understood by those skilled in the art that the sequence of the method steps described in the embodiments of the present disclosure may be modified according to the actual needs unless the sequence of the method steps is specifically stated, and may even be performed simultaneously or partially simultaneously.

On the other hand, according to the embodiments of the present disclosure, the electronic device used to execute the video encoding method may be regarded as a video encoder, and the electronic device used to execute the video decoding method may be regarded as a video decoder. The video encoder and the video decoder may be implemented at the video provider and the video receiver, respectively. Alternatively, the video encoder and the video decoder may be integrated in the same device. The video encoder along with the video decoder can be considered as a video codec system or facilities, or as part of them.

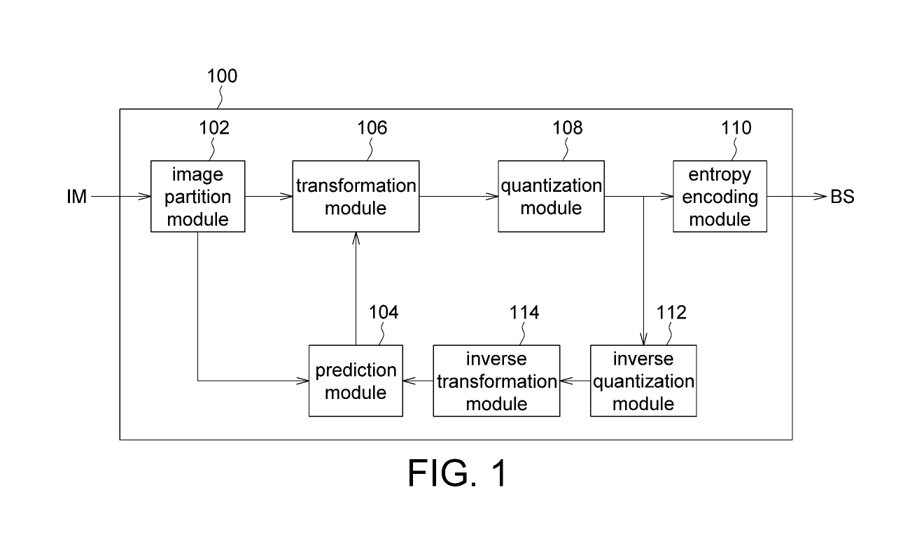

FIG. 1 is a block diagram of a video encoder 100 according to an embodiment of the present disclosure. The video encoder 100 includes an image partition module 102, a prediction module 104, a transformation module 106, a quantization module 108, an entropy encoding module 110, an inverse quantization module 112, and an inverse transformation module 114. These modules may be implemented through software (e.g., programs, files and data), hardware (e.g., logic circuits) or the combination thereof included in the processor of the video encoder 100, and may be operated under the control of the processor to perform the video encoding method of the present disclosure.

The image partition module 102 may receive an image IM and partition it into a plurality of blocks. The image IM may be one image frame included in a video sequence. The blocks may be largest coding units (LCUs) (or called coding tree units (CTUs)). Each block has a plurality of pixels arranged in a matrix of L x L, where L is a positive integer.

The video encoder 100 may perform an encoding process on each block of the image IM to generate the corresponding encoded video data BS. The encoding process may be implemented through, for example, the cooperation of the prediction module 104, the transformation module 106, the quantization module 108, the entropy encoding module 110, the inverse quantization module 112, and the inverse transformation module 114.

The prediction module 104 may uniformly partition each block of the image IM into a plurality of sub-blocks with the same size, and perform an intra prediction on each sub-block to search for a suitable prediction mode for each sub-block. The prediction module 104 may further perform an index encoding process on the sub-blocks in one block according to the searched prediction modes, and generate an index map accordingly. The prediction module 104 may also compress the index map into encoded index information for the subsequent encoding processing.

The transformation module 106 may perform a transformation process on the block according to the encoded index information, so as to convert the block into a transform block. The transformation process may be a discrete cosine transform (DCT) algorithm or other transformation algorithm.

For example, the transformation module 106 may first recover the predicted block according to the encoded index information, then compare the predicted block with the original block of the image IM to generate residual data, and then perform the transformation process on the residual data to generate the transformed data.

The residual data may be presented as a transform unit for processing. In an embodiment, the transform unit has the same size with the sub-block, that is, the transformation module 106 does not have to further partition the sub-block during the execution of the transformation process.

The quantization module 108 may quantize the transformed data according to a predetermined quantization step to generate the quantized data. The quantized data is then provided to the entropy encoding module 110 by the quantization module 108.

The entropy encoding module 110 may perform an entropy encoding process on the quantized data to generate the encoded video data BS. The entropy encoding process may be, for example, syntax-based context adaptive binary arithmetic coding (SBAC), context adaptive binary arithmetic coding (CABAC), context adaptive variable length coding, or other suitable entropy coding techniques.

The inverse quantization module 112 and the inverse transformation module 114 may perform the inverse quantization process and the inverse transformation process on the residual data defined in the frequency domain, respectively, to reconstruct the data defined in the pixel value domain. The reconstructed data may be provided to the prediction module 104 for prediction. The inverse transformation process and the inverse quantization process may be the inverse processing of the transformation module 106 and the inverse processing of the quantization module 108, respectively. The inverse quantization process and the inverse transformation process can be realized by the inverse quantization technology and the inverse transformation technology used in current video encoder(s) and video decoder(s).

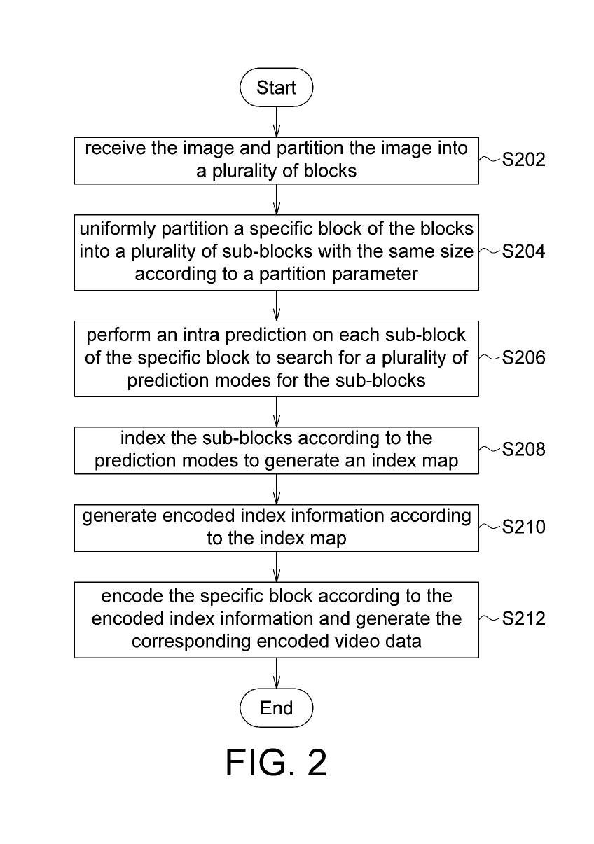

FIG. 2 is a flow chart of a video encoding method according to an embodiment of the invention. The encoding process may be implemented, for example, by the video encoder 100 of FIG. 1 or by the electronic device including the processor.

In step S202, the image partition module 102 receives the image IM and partitions the image IM into a plurality of blocks.

In step S204, the prediction module 104 uniformly partitions a specific block of the blocks into a plurality of sub-blocks with the same size according to a partition parameter, wherein the partition parameter determines the depth of partition of the specific block.

In an embodiment, the partition parameter may denote a depth of partition for the specific block. For example, when the depth of partition=1, the specific block is divided into 1×1 sub-block; when the depth of partition=2, the specific block is divided into 2×2 sub-blocks; when the depth of partition=K, the specific block is divided into K×K sub-blocks, and so on. In another embodiment, when the depth of partition=n, the specific block is partitioned by n-th power of m, where m and n are positive integers. For example, when the depth of partition=2, the specific block is divided into 4×4 sub-blocks if m=2.

In an embodiment, the partition parameter may be determined based on a difference between a reference value and a selected depth value, wherein the selected depth value indicates the depth of partition for uniformly partitioning the specific block. In this embodiment, the partition parameter (δ) may be expressed as follows for example:

δ=Bdv−Rdv equation (1)

where Bdv is the reference value and Rdv is the selected depth value. For example, given that Bdv is preset as 2, then if the specific block is required to be evenly partitioned into 3×3 sub-blocks (Rdv=3), the partition parameter (δ) can be represented as 1. In this way, the amount of data to be transferred can be reduced.

In an embodiment, the partition parameter may be included in a picture parameter set or a slice header.

In step S206, the prediction module 104 performs an intra prediction on each sub-block of the specific block to search for a plurality of prediction modes for the sub-blocks.

For example, the intra prediction may include operations of: selecting a neighboring pixel of a sub-block as a predictor, and interpolating (or other numerical prediction algorithms) the predictor in different prediction modes to predict the pixel content of the sub-block. The prediction module 104 may select, from the different prediction modes, the best prediction mode for the sub-block according to the costs of the different prediction modes. Different prediction modes may correspond to different prediction angles. The number of the prediction modes may vary depending on the video encoding protocol used.

In step S208, the prediction module 104 indexes the sub-blocks according to the prediction modes and generate an index map accordingly. The index map may include a plurality of prediction mode indexes for denoting the prediction modes. For example, if a specific block includes 3×3 sub-blocks, each sub-block is given an index number to indicate its corresponding prediction mode. In this way, the specific block may be converted into an index map including 3×3 (=9) prediction mode indexes.

In step S210, the prediction module 104 generates encoded index information according to the index map. For example, the prediction module 104 may consider the index map as a code book and compress it by using a code book compressing approach to generate the encoded index information.

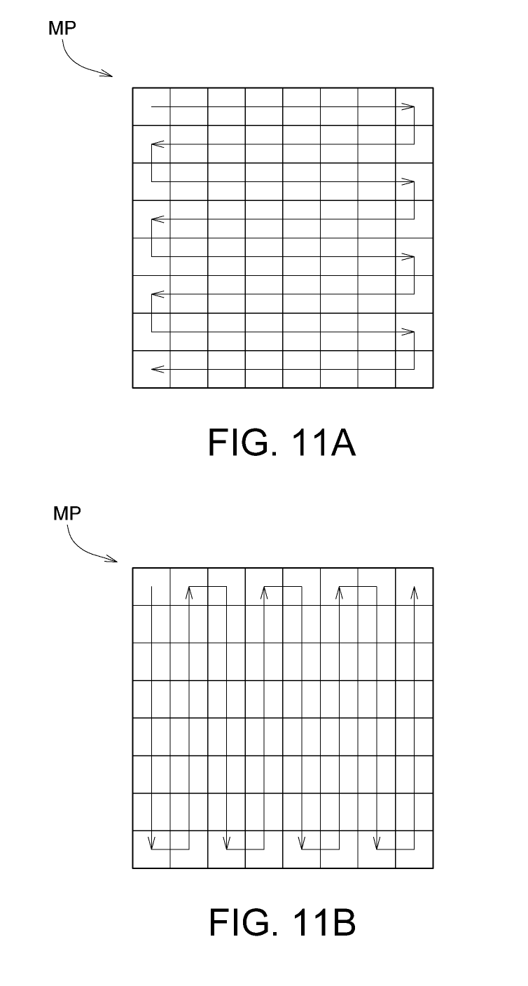

In an embodiment, in order to further improve the overall compression ratio, the prediction module 104 may adjust the value of one or more of the prediction mode indexes in the index map before the map compression. The details will be described later in conjunction with FIG. 10.

In step S212, the video encoder 100 encodes the specific block according to the encoded index information and generates the corresponding encoded video data. For example, the transformation module 106 may first restore the predicted block according to the encoded index information, then compare the predicted block with the original block in the image IM to generate the residual data, and then transform the residual data into the transformed data. Afterwards, through the processing of the quantization module 108 and the entropy encoding module 110, the encoded video data for the specific block is generated.

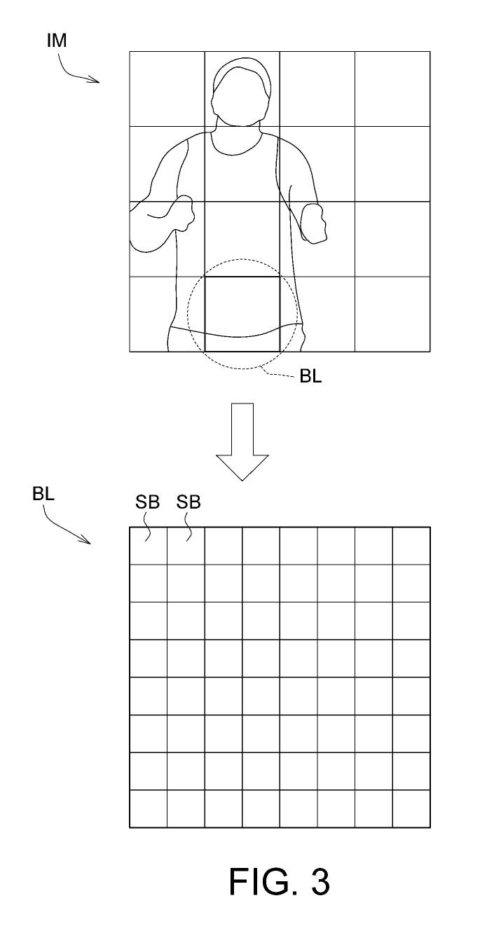

FIG. 3 is a schematic diagram showing that a block BL of the image IM is uniformly partitioned into a plurality of sub-blocks SB with the same size.

In the example of FIG. 3, the image partition module 102 of the video encoder 100 partitions the image IM to be encoded into 4×4 blocks BL, wherein each block BL represents one LCU for example. For a certain block BL to be processed, the prediction module 104 may further divides it into 8×8 sub-blocks SB with the same size for processing according to the partition parameter. Because the prediction module 104 does not need to divide the LCU into sub-blocks with different sizes depending on the image content or other video conditions, there is no need to record or maintain non-uniform partition information, such as quad-tree partition information, during the encoding and decoding processes for the LCU, so that the amount of data required to be processed can be reduced.

It is noted that although in FIG. 3 there are 4×4 blocks BL and 8×8 sub-blocks SB, the present disclosure is not limited thereto. According to the embodiments of the present disclosure, the number of blocks BL and sub-block SB may be arbitrary, depending on what the video application is adopted.

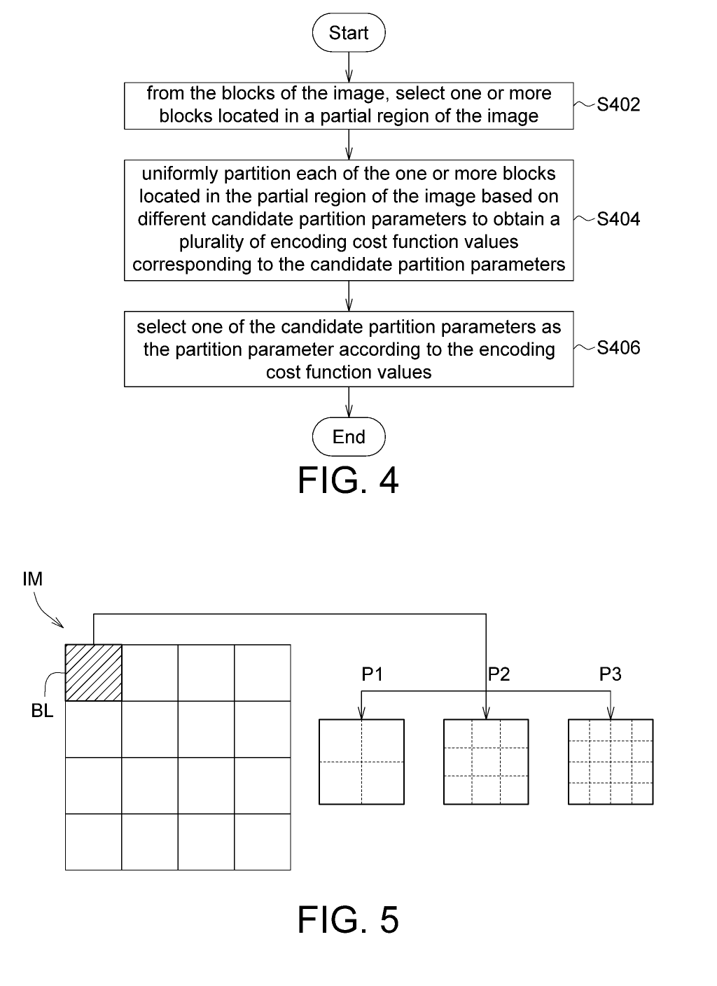

FIG. 4 is a flow chart of determining the partition parameter according to an embodiment of the present disclosure. According to this embodiment, the video encoder 100 may first calculate the encoding cost function values of one or more blocks located in a partial region of the image IM with different candidate partition parameters, and then select one of the candidate partition parameters corresponding to the minimum encoding cost as the partition parameter for the image IM.

As shown in FIG. 4, in step S402, the video encoder 100 selects one or more blocks located in a partial region of the image from the blocks of the image. In an embodiment, the partial region may refer to the upper left corner area or the center area of the image.

In step S404, the video encoder 100 uniformly partitions each of the one or more blocks located in the partial region of the image based on different candidate partition parameters to obtain a plurality of encoding cost function values corresponding to the candidate partition parameters. Various candidate partition parameters may correspond to different depths of partition. The encoding cost function may be, for example, a rate-distortion optimization (RDO) cost function, a sum of absolute difference (SAD) cost function, a sum of absolute transformed difference (SATD) cost function, and so on.

In step S406, the video encoder 100 selects one of the candidate partition parameters as the partition parameter according to the encoding cost function values. For example, the video encoder 100 may select the candidate partition parameter with the minimum encoding cost as the partition parameter for the image IM.

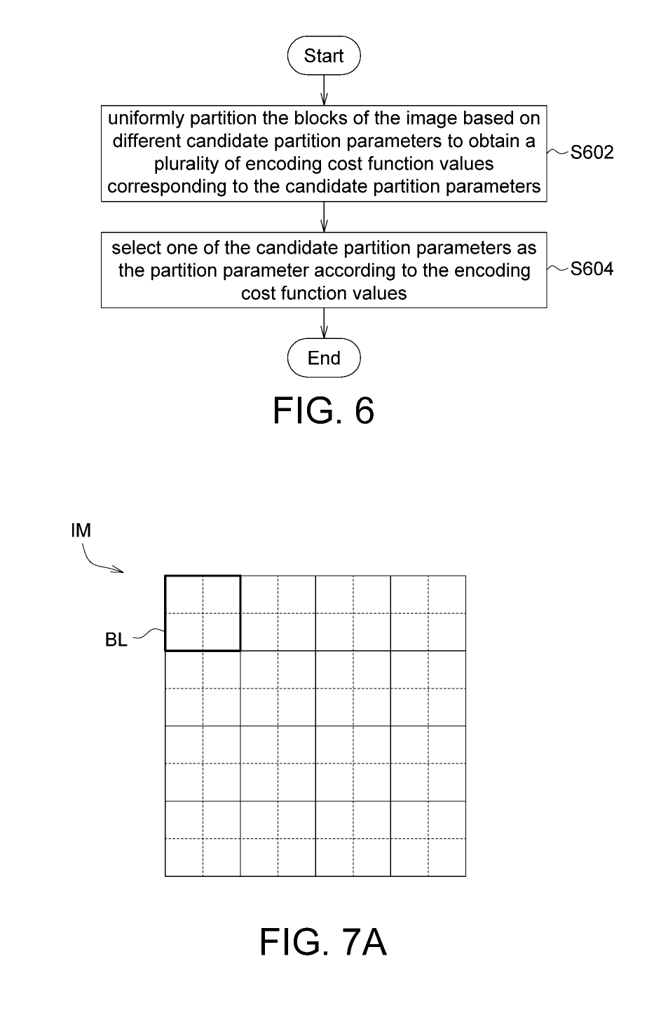

FIG. 5 is a schematic diagram of determining the partition parameter according to the flow chart of FIG. 4. In the example of FIG. 5, the video encoder 100 may partition the block BL located in the upper left corner of the image IM into 2×2 sub-blocks, 3×3 sub-blocks and 4×4 sub-blocks according to different candidate partition parameters P1, P2 and P3, respectively.

The video encoder 100 may calculate the encoding cost function values for the candidate partition parameters P1, P2, and P3, respectively, and select one of the candidate partition parameters corresponding to the minimum encoding cost function value as the partition parameter for the image IM.

For example, if the video encoder 100 determines that it gives the minimum RDO function value for the block BL when the block BL is partitioned based on the candidate partition parameter P2, the video encoder 100 may select the candidate partition parameter P2 as the partition parameter for partitioning the image IM.

Although in FIG. 5 the partition parameter of the image IM is determined by partitioning one block BL located in the upper left corner of the image IM based on different candidate partition parameters, the present disclosure is not limited thereto. In some embodiments, the value of the partition parameter may be determined by partitioning one or more blocks located in one or more partial regions of the image IM based on different candidate partition parameters.

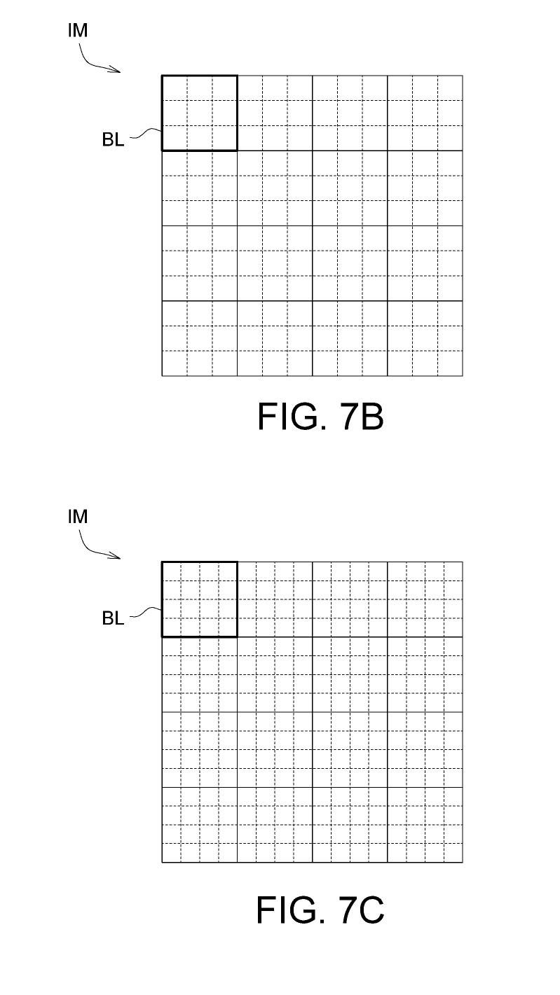

FIG. 6 is a flow chart of determining the partition parameter according to another embodiment of the present disclosure. According to this embodiment, the video encoder 100 may partition all the blocks BL in the image IM based on different candidate partition parameters and calculate the respective encoding cost function values, and then select one of the candidate partition parameters corresponding to the minimum encoding cost as the partition parameter.

As shown in FIG. 6, in step S602, the video encoder 100 uniformly partitions the blocks BL of the image IM based on different candidate partition parameters to obtain a plurality of encoding cost function values corresponding to the candidate partition parameters.

In step S604, the video encoder 100 selects one of the candidate partition parameters as the partition parameter according to the encoding cost function values.

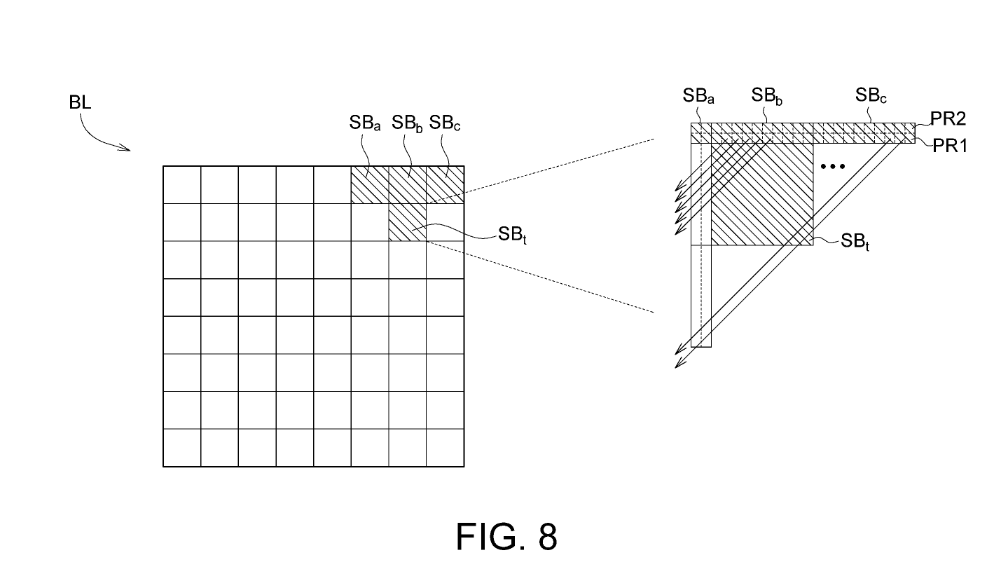

FIGS. 7A to 7C are schematic diagrams of determining the partition parameter according to the flow of FIG. 6. In the example of FIG. 7A, the video encoder 100 partitions each block BL of the image IM into 2×2 sub-blocks according to the candidate partition parameter P1′. In the example of FIG. 7B, the video encoder 100 partitions each block BL of the image IM into 3×3 sub-blocks according to the candidate partition parameter P2′. In the example of FIG. 7C, the video encoder 100 partitions each block BL of the image IM into 4×4 sub-blocks according to the candidate partition parameter P3′.

The video encoder 100 may calculate the encoding cost function values obtained by partitioning the image IM according to the candidate partition parameters P1′, P2′ and P3′, respectively, and encoding the resulted partitioned images correspondingly. The video encoder 100 may then select one of the candidate partition parameters corresponding to the minimum encoding cost as the partition parameter.

In an embodiment, in addition to determining the partition parameter in the above manner, the video encoder 100 may receive a user operating parameter and set the partition parameter according to the user operating parameter. In this way, the user is allowed to set the partition parameter for the image IM manually.

The various embodiments of determining the partition parameter described above can be combined with each other. For example, for different frames of images in a video stream, the video encoder 100 may determine one or more partition parameters for these images in at least one of the following ways: (1) determining the partition parameter(s) based on the embodiment of FIG. 4, (2) determining the partition parameter(s) based on the embodiment of FIGS. 6, and (3) determining the partition parameter(s) based on the user operating parameter.

For example, the video encoder 100 may use the method shown in FIG. 4 to determine the partition parameter for some frames of images in the video stream, and use the method shown in FIG. 5 to determine the partition parameter for the remaining frames of images.

Once the partition parameter for a certain image IM is generated, the video encoder 100 may apply the partition parameter to other image(s) in the video data. For example, once the partition parameter for the first image of a video sequence is determined, the video encoder 100 may also apply the partition parameter to the second to i-th consecutive images to partition these images with the same depth of partition, where i is a positive integer greater than 1. The video encoder 100 may determine another one partition parameter for the (i+1)-th image by conducting the flow of FIG. 4 or the flow of FIG. 6 again, or allow the user to set the partition parameter. Then, the video encoder 100 may apply the new partition parameter to the (i+1)-th to k-th images, so as to determine these images' depth of partition of blocks, where k is a positive integer greater than i+1. In some embodiments, the video encoder 100 may use a single partition parameter for all the images in the video sequence. Alternatively, the video encoder 100 may choose the partition parameter(s) for the images according to the type or requirement of the video data (latency requirement, image quality requirement, etc.).

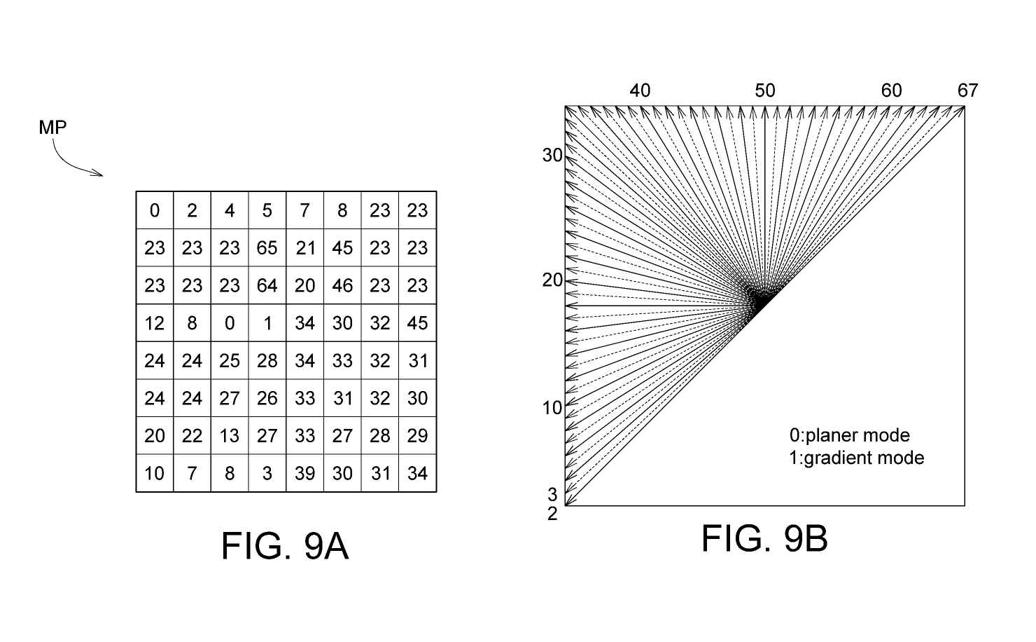

FIG. 8 is a schematic diagram illustrating the intra prediction for a sub-block SBₜ of the block BL. In FIG. 8, the intra prediction is exemplified by predicting the sub-block in a diagonal direction. However, this is merely for illustration, not for limiting the present disclosure.

In the example of FIG. 8, when the prediction module 104 of the video encoder 100 performs the intra prediction on the sub-block SBₜ, the prediction module 104 may use the pixels in the two adjacent pixel rows PR1 and PR2 in the sub-blocks SBₐ to SB_{c} located above and adjacent to the sub-block SBₜ as predictors, wherein the pixel row PR1 is adjacent to the upper edge of the sub-block SBₜ, and the pixel row PR2 is adjacent to upper edge of the pixel row PR1. Each of the pixel rows PR1 and PR2 includes a plurality of pixels. The prediction module 104 may predict the pixel values of the pixels in the sub-block SBₜ according to an interpolation result along the lower left direction from the pixels in the neighboring pixel rows PR1 and PR2. Since pixels in more than one adjacent pixel row are used as predictors in this example, the performance of the intra prediction for sub-block SBₜ can be improved.

However, it is noted that the present disclosure is not limited to the above example. When performing the intra prediction on a sub-block, the prediction module may select the pixels in one or more pixel rows adjacent to the sub-block as predictors.

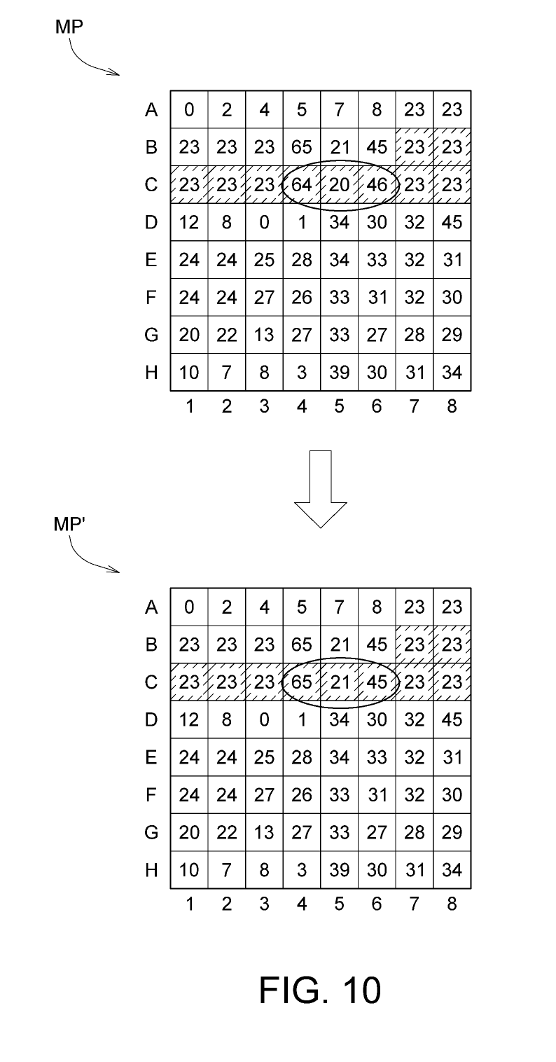

FIG. 9A is a schematic diagram of an index map MP generated by indexing each sub-block SB in the block BL. In the example of FIG. 9A, the index map MP includes 8×8 prediction mode indexes, with each of which corresponding to a prediction mode for a sub-block SB, that is, the best prediction angle for the sub-block SB found by the intra prediction.

FIG. 9B is a schematic diagram illustrating a plurality of prediction angles (prediction modes) and the corresponding prediction mode indexes. As shown in FIG. 9B, each of the prediction angles corresponds to a prediction mode index (e.g., 2 to 67). In addition, when the prediction mode index=0, for example, it may indicate a planar mode for estimating the average value of the entire block, and when the prediction mode index=1, for example, it may indicate a gradient mode in which the gradation of the entire block is estimated. When two prediction angles have similar values, their corresponding prediction mode indexes are also close to each other. For example, as shown in FIG. 9B, the prediction angle corresponding to prediction mode index=2 is similar to the prediction angle corresponding to prediction mode index=3. It is understood that the disclosure is not limited to the above example, the values of the prediction mode indexes, the number of the prediction modes, etc., can be modified according to the used video codec specifications.

FIG. 10 is a schematic diagram of an adjusted index map MP′ generated by adjusting the prediction mode indexes in the index map MP.

According to embodiments of the present disclosure, the index map MP may be deemed as a code book and be compressed to encoded index information. The encoded index information may include a copy mode flag and a run value flag, and may further include an index flag. The copy mode flag indicates a copy direction. The run value flag indicates a specific number, wherein for a sub-block collection including the specific number of consecutive sub-blocks comprised in the sub-blocks SB of the block BL, the prediction mode index corresponding to each sub-block in the sub-block collection is the same as the prediction mode index corresponding to an adjacent sub-block in the copy direction. The index flag indicates a specific prediction mode index corresponding to a specific sub-block, wherein the specific prediction mode index is the same as the prediction mode indexes corresponding to the consecutive sub-blocks in the sub-block collection.

For better illustration, the coordinate positions of the respective sub-blocks in the index map MP are denoted by (X, Y), where X indicates the horizontal axis coordinates 1 to 8, and Y indicates the vertical axis coordinates A to H. For example, a sub-block located at (7, A) means that the sub-block is located at column “7”, row “A” of the index map MP. It can be seen from the index map MP that the prediction mode indexes are “23” for the sub-blocks located at coordinates (7, A), (8, A), (1, B), (2, B) and (3, B). In terms of a horizontal raster scan order for the index map MP, these consecutive sub-blocks constitute a sub-block collection. Therefore, for this set of prediction mode indexes, it can be represented by setting the copy mode flag to a “copy left mode flag” to indicate that the copy direction is “leftward”, setting the index flag to “mode index #23” to indicate that the prediction mode index to be copied is “23,” and setting the run value to “run value (5)” to indicate that the sub-block collection includes “5” consecutive sub-blocks. That is, the prediction mode index of the sub-block located at the coordinates (3, B) is copied from the prediction mode index of the sub-block located at the coordinates (2, B) which is on the left to the sub-block located at the coordinates (3, B); the prediction mode index of the sub-block located at the coordinates (2, B) is copied from the prediction mode index of the sub-block located at the coordinates (1, B) which is on the left to the sub-block located at the coordinates (2, B), and so on. In addition, for non-consecutive prediction mode index(s) such as the prediction mode index for the sub-block located at the coordinates (2, A), the run value flag may be set to “run value (0)” and the index flag may be set to “mode index #2”.

In the above example, “run value (5)” indicates that the sub-block collection to be copied includes 5 sub-blocks because the number of copies of the prediction mode indexes indicated by the run value flag is counted from 1. However, the present disclosure is not limited thereto. In an embodiment, the number of copies of the prediction mode indexes for the sub-blocks indicated by the run value flag may start from 0. In such situation, when the run value flag is set as “run value (4),” it indicates that there are “5” consecutive sub-blocks in the sub-block collection of which the corresponding prediction mode indexes are to be copied.

In an embodiment, the copy mode flag may be set as “copy above run mode flag” to indicate that the copy direction is “upward”. For example, when the copy mode flag is set as “copy above run mode flag” and the run value flag is set as “run value (10),” it means that the prediction mode indexes of 10 consecutive sub-blocks are copied from the prediction mode indexes of the sub-blocks adjacent to the 10 consecutive sub-blocks' upper edges. In another embodiment, if the number of copies of the prediction mode indexes indicated by the run value flag is counted from 0, then when the run value flag is set as “run value (9),” it means that the prediction mode indexes of 10 consecutive sub-blocks are copied from the prediction mode indexes of the sub-blocks adjacent to the 10 consecutive sub-blocks' upper edges.

In an embodiment, when the run value flag is set to a specific value, it means that the prediction mode indexes of all sub-blocks in a block are the same. For example, the specific value may be (but not limited to) “0”.

In the manner described above, the index map MP can be compressed into encoded index information containing one or more copy mode flags, one or more run value flags, and one or more index flags, so that the amount of data required for recording or transmitting the index map MP can be reduced.

In an embodiment, the prediction module 104 may fine-tune the prediction mode index(s) in the index map MP to improve the compression ratio for the index map MP. Specifically, given that the sub-blocks SB in one block BL include a first sub-block and a second sub-block which is adjacent to the first sub-block, and the first sub-block and the second sub-block correspond to a first prediction mode index and a second prediction mode index, respectively, the prediction module 104 may determine whether a difference between the first prediction mode index and the second prediction mode index is within a tolerance, and replace the first prediction mode index with the second prediction mode index when it is determined that the difference falls within the tolerance. In an embodiment, the second sub-block is adjacent to the upper edge or the left edge of the first sub-block, for example.

Taking FIG. 10 as an example and provided that the range of the tolerance (Δ) is −1≤Δ≤1, because in the index map MP, the prediction mode indexes of the sub-blocks located at the coordinates (4, C), (5, C), and (6, C) are “64”, “20” and “46”, respectively, the difference between the prediction mode indexes and the prediction mode indexes, “65”, “21” and “45”, of the sub-blocks located at the coordinates (4, B), (5, B), and (6, B) is merely “1”, which is within the tolerance, so the prediction module 104 may replace the prediction indexes of the sub-blocks located at the coordinates (4, C), (5, C), and (6, C) with “65”, “21” and “45” to generate the index map MP′.

According to the index map MP′, because the prediction mode indexes of the sub-blocks located at the coordinates (7, B), (8, B), and (1, C) to (8, C) are the same with the prediction mode indexes of the sub-blocks adjacent to the upper edges of the sub-blocks located at the coordinates (7, B), (8, B), and (1, C) to (8, C), the prediction mode indexes of the sub-blocks located at the coordinates (7, B), (8, B), and (1, C) to (8, C) may be described by the copy mode flag of “copy above run mode flag” and the run value flag of “run value (10)” to enhance the compression efficiency.

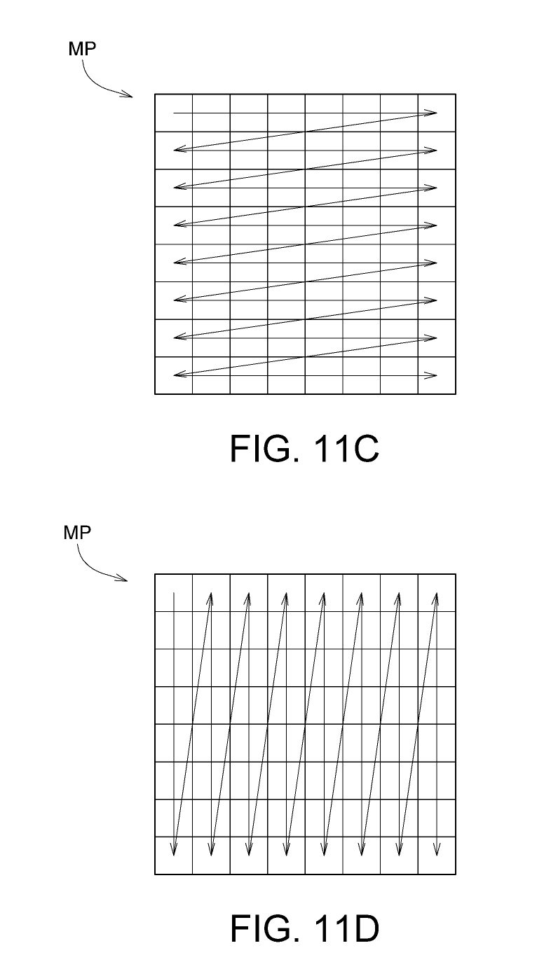

FIG. 11A to FIG. 11D illustrate examples of scanning patterns for the index map MP. The scanning pattern refers to a specific scanning sequence used by the prediction module 104 when compressing the index map MP. Different scan sequences may define different sub-block collections of consecutive sub-blocks, so the copy flag(s), the run value flag(s) and the index flag(s) will be generated correspondingly to describe the index map MP during the compression.

As shown in FIG. 11A, a horizontal snake scan order pattern is applied to the index map MP. As also shown in FIG. 11B, a vertical snake scan order pattern is applied to the index map MP. As also shown in FIG. 11C, a horizontal line-by-line scan order is applied to the index map MP. As also shown in FIG. 11D, a vertical line-by-line scan pattern is applied to the index map MP. As also shown in FIG. 11E, a diagonal scan pattern is applied to the index map MP.

It should be noted that the above embodiments are not exhaustive or limiting. In some applications, suitable combinations and modifications of one or more of these embodiments are permissible.

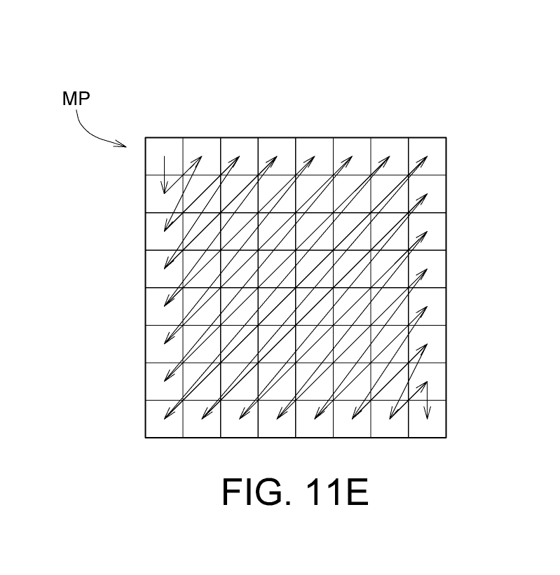

FIG. 12 is a block diagram of a video decoder 1200 according to an embodiment of the present disclosure. The video decoder 1200 includes a receiving module 1202 and a decoding module 1204. The receiving module 1102 may receive the encoded video data BS. The decoding module 1104 may reconstruct the encoded video data BS as the corresponding decoded video data DE.

The receiving module 1102 and the decoding module 1104 may be implemented through software (e.g., programs, files and data), hardware (e.g., logic circuits) or the combination thereof included in the processor of the video decoder 1200, and may be operated under the control of the processor to perform the video decoding method of the present disclosure.

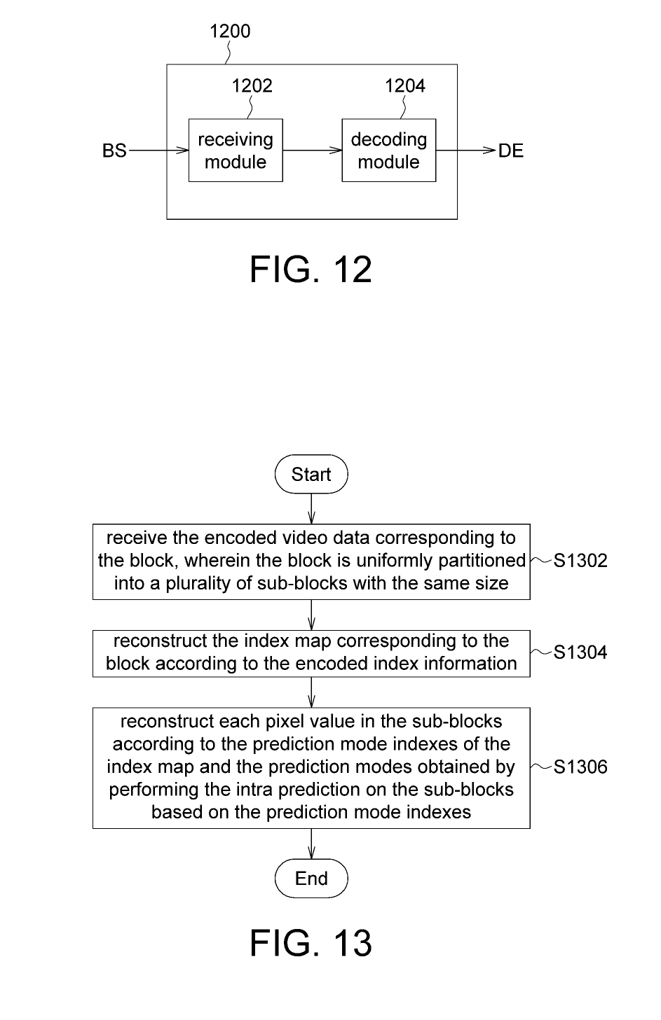

FIG. 13 is a flow chart of a video decoding method according to an embodiment of the present disclosure. The video decoding method may be implemented, for example, by the video decoder 1200 of FIG. 12 or by the electronic device including the processor.

In step S1302, the receiving module 1102 receives the encoded video data BS corresponding to the block, wherein the block is uniformly partitioned into a plurality of sub-blocks with the same size.

In step S1304, the decoding module 1104 reconstructs the index map corresponding to the block according to the encoded index information, wherein the index map includes a plurality of prediction mode indexes respectively corresponding to a plurality of prediction modes obtained by performing an intra prediction on the respective sub-blocks. The encoded index information may be, for example, carried by the encoded video data BS or transmitted as an individual message. The decoding module 1104 may also obtain the partition parameter of the block from the picture parameter set or the slice header.

In step S1306, the decoding module 1104 reconstructs each pixel value in the sub-blocks according to the prediction mode indexes of the index map and the prediction modes obtained by performing the intra prediction on the sub-blocks based on the prediction mode indexes. Because the index map records the prediction mode indexes for each sub-block, the decoding module 1104 may reconstruct the pixel value of each sub-block according to the prediction modes represented by the prediction mode indexes.

Based on the above, the present disclosure provides a video encoding method, a video decoding method, a video encoder, and a video decoder. According to the embodiments of the present disclosure, each block in the image is uniformly partitioned into a plurality of sub-blocks with the same size. In this way, the device does not need to record or process the quad-tree partition information of each block of the image when conducting the image encoding and decoding processes, so that the computation loading on the device can be reduced. In addition, the uniform-partitioned sub-blocks in each block may be indexed after the intra prediction, so that each block in the image may be converted into an indexed map. The index map may be further compressed into encoded index information for the subsequent encoding and decoding processes to improve the codec performance.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A video encoding method implemented by an electronic device including a processor, the video encoding method comprising:
receiving an image by the processor;
partitioning the image into a plurality of blocks by the processor; and
executing an encoding process for each of the blocks by the processor, the encoding process comprising:
partitioning a specific block of the blocks into a plurality of sub-blocks with the same size according to a partition parameter, wherein the partition parameter determines a depth of partition of the specific block;
performing an intra prediction on each of the sub-blocks to search for a plurality of prediction modes for the sub-blocks;
indexing the sub-blocks according to the prediction modes to generate an index map including a plurality of prediction mode indexes for indicating the prediction modes;
generating encoded index information according to the index map; and
encoding the specific block according to the encoded index information to generate corresponding encoded video data.

2. The video encoding method according to claim 1, further comprising:
selecting one or more blocks located in a partial region of the image from the blocks by the processor;
uniformly partitioning each of the one or more blocks located in the partial region of the image based on different candidate partition parameters to obtain a plurality of encoding cost function values corresponding to the candidate partition parameters by the processor; and
selecting one of the candidate partition parameters as the partition parameter according to the encoding cost function values by the processor.

3. The video encoding method according to claim 1, further comprising:
uniformly partitioning the blocks of the image based on different candidate partition parameters to obtain a plurality of encoding cost function values corresponding to the candidate partition parameters by the processor; and
selecting one of the candidate partition parameters as the partition parameter according to the encoding cost function values by the processor.

4. The video encoding method according to claim 1, further comprising:
receiving a user operating parameter by the processor; and
setting the partition parameter according to the user operating parameter by the processor.

5. The video encoding method according to claim 1, wherein the partition parameter is comprised in a picture parameter set or a slice header.

6. The video encoding method according to claim 1, wherein the partition parameter is determined by a difference between a reference value and a selected depth value, wherein the selected depth value indicates a depth of partition for uniformly partitioning the specific block.

7. The video encoding method according to claim 1, wherein the sub-blocks comprise a first sub-block and a second sub-block adjacent to the first sub-block, the first sub-block is corresponding to a first prediction mode index of the prediction mode indexes, the second sub-block is corresponding to a second prediction mode index of the prediction mode indexes, and the video encoding method further comprises:
determining whether a difference between the first prediction mode index and the second prediction mode index is within a tolerance by the processor; and
when the difference falls within the tolerance, replacing the first prediction mode index with the second prediction mode index by the processor.

8. The video encoding method according to claim 7, wherein the second sub-block is adjacent to an upper edge or a left edge of the first sub-block.

9. The video encoding method according to claim 1, wherein the encoded index information comprises:
a copy mode flag indicating a copy direction; and
a run value flag indicating a specific number, wherein for a sub-block collection including the specific number of consecutive sub-blocks, the prediction mode index corresponding to each sub-block of the sub-block collection is the same as the prediction mode index corresponding to an adjacent sub-block in the copy direction.

10. The video encoding method according to claim 9, wherein the encoded index information further comprises:
an index flag indicating a specific prediction mode index corresponding to a specific sub-block of the sub-blocks, wherein the specific prediction mode index is the same as the prediction mode indexes corresponding to the consecutive sub-blocks in the sub-block collection.

11. A video encoder, comprising:
a memory; and
a processor coupled to the memory and configured for:
receiving an image;
partitioning the image into a plurality of blocks; and
executing an encoding process for each of the blocks, the encoding process comprising:
partitioning a specific block of the blocks into a plurality of sub-blocks with the same size according to a partition parameter, wherein the partition parameter determines a depth of partition of the specific block;
performing an intra prediction on each of the sub-blocks to search for a plurality of prediction modes for the sub-blocks;
indexing the sub-blocks according to the prediction modes to generate an index map including a plurality of prediction mode indexes for indicating the prediction modes;
generating encoded index information according to the index map; and
encoding the specific block according to the encoded index information to generate corresponding encoded video data.

12. The video encoder according to claim 11, wherein the processor is further configured for:
selecting one or more blocks located in a partial region of the image from the blocks;
uniformly partitioning each of the one or more blocks located in the partial region of the image based on different candidate partition parameters to obtain a plurality of encoding cost function values corresponding to the candidate partition parameters; and
selecting one of the candidate partition parameters as the partition parameter according to the encoding cost function values.

13. The video encoder according to claim 11, wherein the processor is further configured for:
uniformly partitioning the blocks of the image based on different candidate partition parameters to obtain a plurality of encoding cost function values corresponding to the candidate partition parameters; and
selecting one of the candidate partition parameters as the partition parameter according to the encoding cost function values.

14. The video encoder according to claim 11, wherein the processor is further configured for:
receiving a user operating parameter; and
setting the partition parameter according to the user operating parameter.

15. The video encoder according to claim 11, wherein the partition parameter is comprised in a picture parameter set or a slice header.

16. The video encoder according to claim 11, wherein the partition parameter is determined by a difference between a reference value and a selected depth value, wherein the selected depth value indicates a depth of partition for uniformly partitioning the specific block.

17. The video encoder according to claim 11, wherein the sub-blocks comprise a first sub-block and a second sub-block adjacent to the first sub-block, the first sub-block is corresponding to a first prediction mode index of the prediction mode indexes, the second sub-block is corresponding to a second prediction mode index of the prediction mode indexes, and the processor is further configured for:
determining whether a difference between the first prediction mode index and the second prediction mode index is within a tolerance; and
when the difference falls within the tolerance, replacing the first prediction mode index with the second prediction mode index.

18. The video encoder according to claim 17, wherein the second sub-block is adjacent to an upper edge or a left edge of the first sub-block.

19. The video encoder according to claim 11, wherein the encoded index information comprises:
a copy mode flag indicating a copy direction; and
a run value flag indicating a specific number, wherein for a sub-block collection including the specific number of consecutive sub-blocks, the prediction mode index corresponding to each sub-block of the sub-block collection is the same as the prediction mode index corresponding to an adjacent sub-block in the copy direction.

20. The video encoder according to claim 19, wherein the encoded index information further comprises:
an index flag indicating a specific prediction mode index corresponding to a specific sub-block of the sub-blocks, wherein the specific prediction mode index is the same as the prediction mode indexes corresponding to the consecutive sub-blocks in the sub-block collection.

21. A video decoding method implemented by an electronic device including a processor, the video decoding method comprising:
receiving encoded video data corresponding to a block, wherein the block is uniformly partitioned into a plurality of sub-blocks with the same size;
reconstructing an index map corresponding to the block according to encoded index information, wherein the index map comprises a plurality of prediction mode indexes respectively corresponding to a plurality of prediction modes obtained by performing an intra prediction on the respective sub-blocks; and
reconstructing each pixel value in the sub-blocks according to the prediction mode indexes of the index map and the prediction modes obtained by performing the intra prediction on the sub-blocks based on the prediction mode indexes.

22. The video decoding method according to claim 21, further comprising:
obtaining a partition parameter from a picture parameter set or a slice header, wherein the partition parameter determines a depth of partition of the block.

23. The video decoding method according to claim 21, wherein the encoded index information comprises:
a copy mode flag indicating a copy direction; and
a run value flag indicating a specific number, wherein for a sub-block collection including the specific number of consecutive sub-blocks, the prediction mode index corresponding to each sub-block of the sub-block collection is the same as the prediction mode index corresponding to an adjacent sub-block in the copy direction.

24. The video decoding method according to claim 23, wherein the encoded index information further comprises:
an index flag indicating a specific prediction mode index corresponding to a specific sub-block of the sub-blocks, wherein the specific prediction mode index is the same as the prediction mode indexes corresponding to the consecutive sub-blocks in the sub-block collection.

25. A video decoder, comprising:
a memory; and
a processor coupled to the memory and configured for:
receiving encoded video data corresponding to a block, wherein the block is uniformly partitioned into a plurality of sub-blocks with the same size;
reconstructing an index map corresponding to the block according to encoded index information, wherein the index map comprises a plurality of prediction mode indexes respectively corresponding to a plurality of prediction modes obtained by performing an intra prediction on the respective sub-blocks; and
reconstructing each pixel value in the sub-blocks according to the prediction mode indexes of the index map and the prediction modes obtained by performing the intra prediction on the sub-blocks based on the prediction mode indexes.

26. The video decoder according to claim 25, wherein the processor is further configured for:
obtaining a partition parameter from a picture parameter set or a slice header, wherein the partition parameter determines a depth of partition of the block.

27. The video decoder according to claim 25, wherein the encoded index information comprises:
a copy mode flag indicating a copy direction; and
a run value flag indicating a specific number, wherein for a sub-block collection including the specific number of consecutive sub-blocks, the prediction mode index corresponding to each sub-block of the sub-block collection is the same as the prediction mode index corresponding to an adjacent sub-block in the copy direction.

28. The video decoder according to claim 27, wherein the encoded index information further comprises:
an index flag indicating a specific prediction mode index corresponding to a specific sub-block of the sub-blocks, wherein the specific prediction mode index is the same as the prediction mode indexes corresponding to the consecutive sub-blocks in the sub-block collection.
